(19) United States
(12) Patent Application Publication
(10) Pub. No.: US 2019/0304273 A1
(43) Pub. Date: Oct. 3, 2019

(54) IMAGE SURVEILLANCE DEVICE AND METHOD OF PROCESSING IMAGES

(71) Applicant: HON HAI PRECISION INDUSTRY CO., LTD., New Taipei (TW)

(72) Inventor: TE-EN TSENG, New Taipei (TW)

(21) Appl. No.: 16/034,737

(22) Filed: Jul. 13, 2018

Related U.S. Application Data
(60) Provisional application No. 62/648,950, filed on Mar. 28, 2018.

(51) Int. Cl. G08B 13/196; G06K 9/00

(52) U.S. Cl. CPC G08B 13/19613; G08B 13/19671; G06K 9/00771; G08B 13/19645; G06K 9/00664; G08B 13/19656

(57) ABSTRACT

An image surveillance device includes a camera unit, a communication unit, and a processing unit. The processing unit is configured to obtain an identity tag of the image surveillance device, obtain images captured by the camera unit, recognize the images and establish metadata of the images, process the images according to an image processing algorithm, and send the processed images, the metadata, and the identity tag of the image surveillance device to a server.

### FIELD

The subject matter herein generally relates to surveillance technology, and more particularly to an image surveillance device and a method for processing images captured by the image surveillance device.

### BACKGROUND

Generally, surveillance devices work passively and require a user to monitor images captured by the surveillance device.

### BRIEF DESCRIPTION OF THE DRAWINGS

Implementations of the present disclosure will now be described, by way of example only, with reference to the attached figures.

FIG. 1 is a block diagram of an embodiment of at least one image surveillance device in communication with a server.

FIG. 2 is a block diagram of function modules of an image surveillance system implemented in the image surveillance device and the server.

FIG. 3 is a diagram of a location relationship table.

FIG. 4 is flow chart of an image processing method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

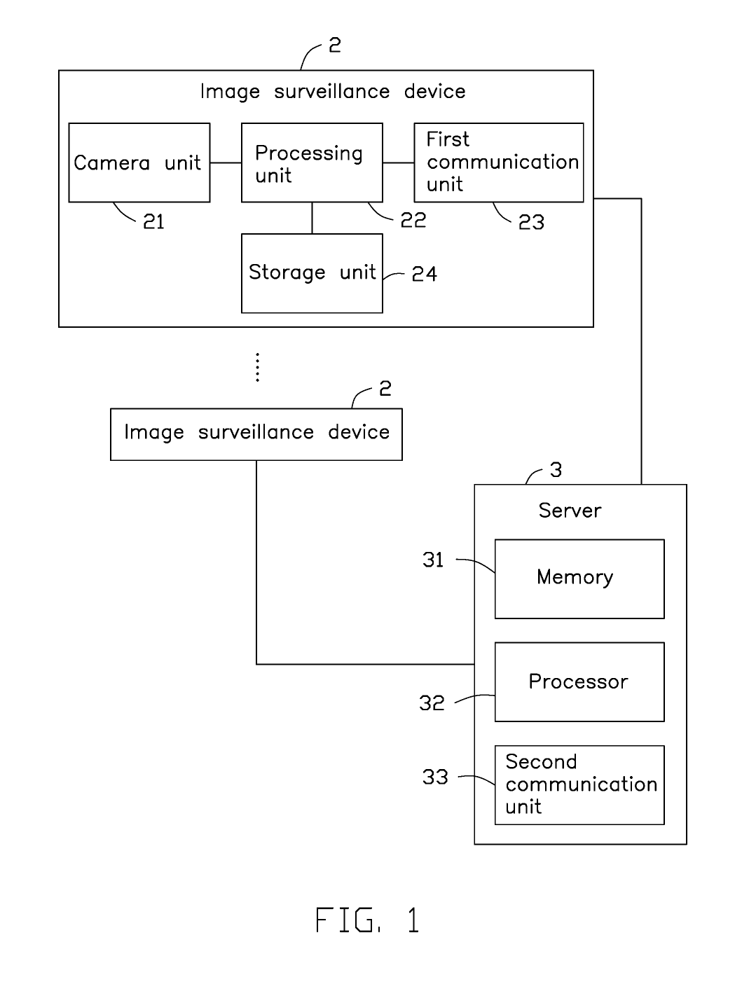

FIG. 1 illustrates an embodiment of an image surveillance device 2 (hereinafter “the device 2”). At least one device 2 is in communication with a server 3. The device 2 captures images and obtains metadata of the images. The device 2 sends the images and the metadata to the server 3. The server 3 receives and stores the images and the metadata and generates a corresponding prompt according to the images and the metadata.

In at least one embodiment, the device 2 includes a camera unit 21, a processing unit 22, a communication unit 23, and a storage unit 24. The camera unit 21, the communication unit 23, and the storage unit 24 are each coupled to the processing unit 22. The camera unit 21 captures images and sends the images to the processing unit 22. The camera unit 21 may be a camera sensor. The processing unit 22 recognizes the images and obtains the metadata from the images. In at least one embodiment, the processing unit 22 recognizes an object in the images captured by the camera unit 21. For example, the object may be a person or a face of a person. After the processing unit 22 recognizes the object, the processing unit 22 establishes an identity tag of the object and records a time period of the object appearing in the images. The identity tag of the object and the recorded time period of the object appearing in the images are treated as the metadata. The processing unit 22 processes the images according to an image processing algorithm. The processing unit 22 further obtains an identity tag of the camera unit 21 and sends the processed images, the metadata, and the identity tag of the camera unit 21 to the server 3 through the communication unit 23. In at least one embodiment, the communication unit 23 may establish communication by WIFI, BLUETOOTH, or a 3G/4G network. The processing unit 22 may send the images and the metadata through the communication unit 23 to the server 3. In another embodiment, the communication unit 23 is a twisted pair. The processing unit 22 may be a central processing unit, a microprocessing unit, or other data processing chip. The storage unit 24 stores data and/or software instruction. For example, the storage unit 24 may store the images and the metadata of the images. The storage unit 24 may be an internal storage of the device 2, such as a hard disk of the camera unit 2. In another embodiment, the storage unit 24 may be an external storage device of the camera unit 2, such as a smart media card, a secure digital card, a flash card, or the like.

In at least one embodiment, the server 3 may be a computer, a workstation, a cloud server, or the like. The server 3 includes a memory 31, a processor 32, and a communication unit 33. The memory 31 and the communication unit 33 are each coupled to the processor 32. The processor 32 receives and stores the images, the metadata, and the identity tag of the camera unit 21 sent by the device 2 through the communication unit 33 in the memory 31. The processor 32 generates a corresponding prompt according to the images, the metadata, and the identity tag of the camera unit 21. In at least one embodiment, the communication unit 33 may communicate wirelessly, such as through WIFI, BLUETOOTH, or a 3G/4G network. In another embodiment, the communication unit 33 may be a wired communication unit, such as a twisted pair. The memory 31 may be an internal memory of the server 3, such as a hard dish. In another embodiment, the memory 31 may be an external storage device of the server 3, such as a smart media card, a secure digital card, a flash card, or the like. The processor 32 may be a central processing unit, a microprocessing unit, or other data processing chip.

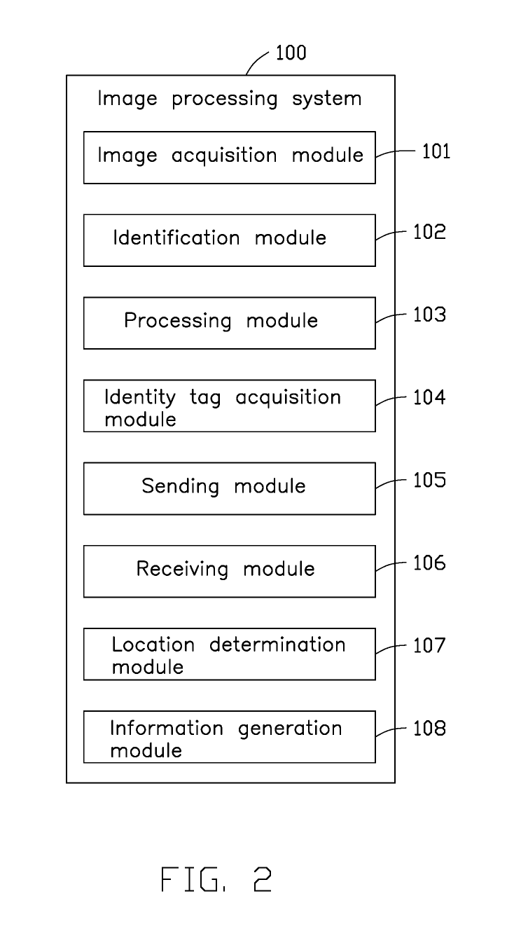

FIG. 2 illustrates an embodiment of an image processing system 100. The image processing system 100 includes a plurality of modules executed in the device 2 and the server 3. The image processing system 100 includes an image acquisition module 101, an identification module 102, a processing module 103, an identity tag acquisition module 104, a sending module 105, a receiving module 106, a location determination module 107, and an information generation module 108. The image acquisition module 101, the identification module 102, the processing module 103, the identity tag acquisition module 104, and the sending module 105 are stored in the storage unit 24 of the device 2 and executed by the processing unit 22. The receiving module 106, the location determination module 107, and the information generation module 108 are saved in the memory 31 of the server 3 and executed by the processor 32. In another embodiment, the image acquisition module 101, the identification module 102, the processing module 103, the identity tag acquisition module 104, and the sending module 105 are embedded in the processing unit 22 of the device 2, and the receiving module 106, the location determination module 107, and the information generation module 108 are embedded in the processor 32 of the server 3.

The image acquisition module 101 is implemented in the device 2 and obtains the images captured by the camera unit 21.

The recognition module 102 is implemented in the device 2 and recognizes the images and establishes the metadata of the images. The metadata includes the identity tag of the object in the images and the recorded time period of the object appearing in the images. The recognition module 102 first recognizes the object in the images as a person, a face of a person, or a non-human object and then sets the person, face of a person, or non-human object as the object. Then, the recognition module 102 establishes the identity tag of the object and records the time period of the object appearing in the images. Then, the recognition module 102 sets the identity tag of the object and the time period of the object appearing in the images as the metadata. In at least one embodiment, the identity tag of the object is made up of letters and numbers.

The processing module 103 is implemented in the device 2 and processes the images according to an image processing algorithm. In at least one embodiment, the image processing algorithm processes the images according to contrast, automatic image exposure, automatic image balance, local and global contrast optimization, image angle change processing, image sharpening, image scaling, and color space conversion processing. In another embodiment, the image processing algorithm further enhances color of the images.

The identity tag acquisition module 104 is implemented in the device 2 and obtains the identity tag of the device 2. In at least one embodiment, the identity tag of the device 2 is made up of letters and numbers. The identity tag of the device 2 is stored in the storage unit 24. The identity tag acquisition module 104 obtains the identity tag of the device 2 from the storage unit 24.

The sending module 105 is implemented in the device 2 and sends the identity tag of the device 2, the processed images, and the metadata through the communication unit 23 to the server 3 for the server 3 to generate a corresponding prompt.

The receiving module 106 is implemented in the server 3 receives the identity tag of the device 2, the processed images, and the metadata through the communication unit 33.

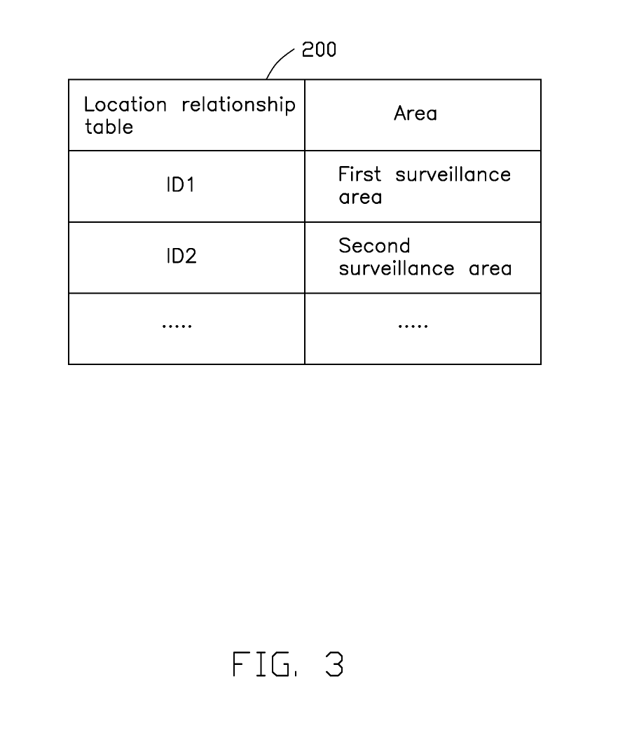

The location determination module 107 is implemented in the server 3 and determines a location of the object in the images by searching a location relationship table 200 according to the identity tag of the device 2. Referring to FIG. 3, the location relationship table 200 records a relationship between a plurality of devices 2 and a corresponding surveillance area of the plurality of devices 2.

The information generation module 108 is implemented in the server 3 and generates the corresponding prompt according to the location of the object and the time period of the object appearing in the images.

In at least one embodiment, the surveillance area of each device 2 corresponds to a surveillance area of a shop. The information generation module 108 is configured to determine whether a length of time of the object remaining in the surveillance area of the shop exceeds a predetermined length of time. When the length of time of the object remaining in the surveillance area exceeds the predetermined length of time, the information generation module 108 generates a prompt that the object likes merchandise of the area of the shop. In at least one embodiment, the information generation module 108 determines whether the identity tag of the object is recorded in a first database. The first database stores identity tags of a plurality of membership customers of the shop. When it is determined that the identity tag of the object matches the identity tag of one of the membership customers in the first database, the information generation module 108 generates a prompt that a membership customer is in the shop. Thus, an employee of the shop will know that the membership customer is in the shop and will know to greet the membership customer.

In at least one embodiment, the surveillance area of each device 2 corresponds to a surveillance area of an office. The information generation module 108 is configured to receive a command to identify the object and generate a prompt to notify that the object is located in the corresponding surveillance area of the office.

In at least one embodiment, the surveillance area of each device 2 corresponds to a surveillance area of an entrance. The information generation module 108 is configured to determine whether the identity tag of the object is recorded in a second database. The second database records a plurality of identity tags that have received authorization. When the information generation module 108 determines that the identity tag of the object is not recorded in the second database, the information generation module 108 generates a corresponding prompt to alarm that a stranger is located in the corresponding surveillance area of the entrance.

In at least one embodiment, the surveillance area of each device 2 corresponds to a surveillance area of an entrance, and the information generation module 108 is configured to determine whether a time period of the object appearing in the location is within a predetermined time period. When the time period of the object appearing in the location is not within the predetermined time period, the information generation module 108 generates a corresponding prompt to alarm that the object is located in the corresponding surveillance area of the entrance outside of the predetermined time period.

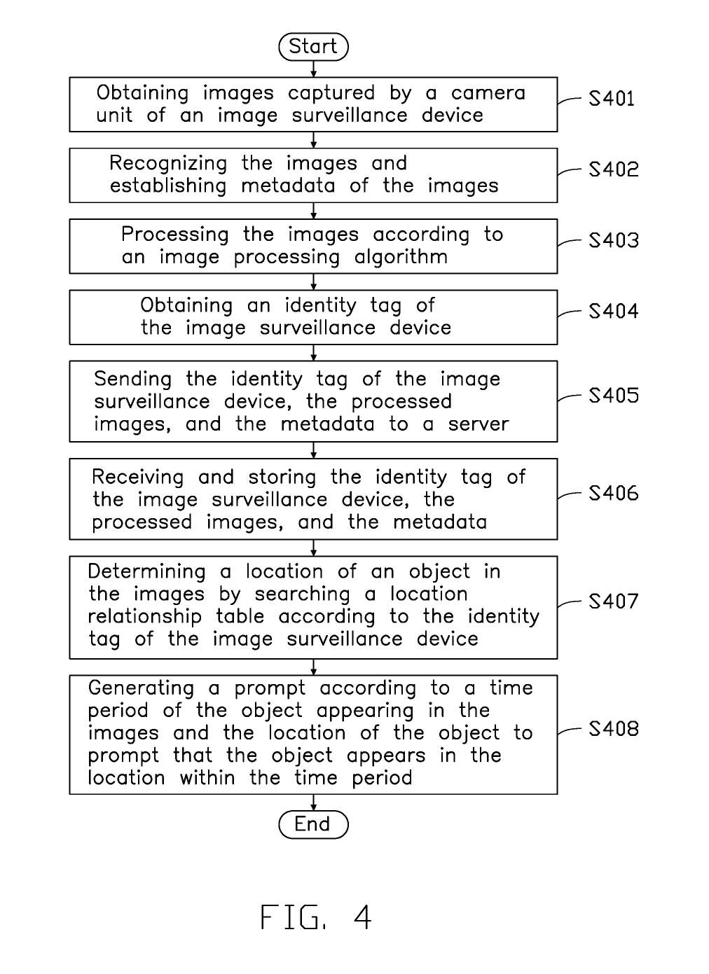

FIG. 4 illustrates a flowchart of an exemplary image processing method. The example method is provided by way of example, as there are a variety of ways to carry out the method. The method described below can be carried out using the configurations illustrated in FIGS. 1-3, for example, and various elements of these figures are referenced in explaining the example method. Each block shown in FIG. 4 represents one or more processes, methods, or subroutines carried out in the example method. Furthermore, the illustrated order of blocks is by example only, and the order of the blocks can be changed. Additional blocks can be added or fewer blocks can be utilized, without departing from this disclosure. The example method can begin at block S401.

At block S401, the images captured by the camera unit 21 are obtained.

At block S402, the images are recognized and metadata of the images is established. The metadata includes the identity tag of the object and the recorded time period of the object appearing in the images.

In at least one embodiment, the object in the images is first recognized as a person, a face of a person, or a non-human object, and then the person, face of a person, or non-human object is set as the object. Then, the identity tag of the object is set and the time period of the object appearing in the images is recorded. Then, the identity tag of the object and the time period of the object appearing in the images are set as the metadata. In at least one embodiment, the identity tag of the object is made up of letters and numbers.

At block S403, the images are processed according to an image processing algorithm. In at least one embodiment, the image processing algorithm processes the images according to contrast, automatic image exposure, automatic image balance, local and global contrast optimization, image angle change processing, image sharpening, image scaling, and color space conversion processing. In another embodiment, the image processing algorithm further enhances color of the images.

At block S404, the identity tag of the device 2 is obtained. In at least one embodiment, the identity tag of the device 2 is made up of letters and numbers. The identity tag of the device 2 is stored in the storage unit 24.

At block S405, the identity tag of the device 2, the processed images, and the metadata are sent to the server 3.

At block S406, the identity tag of the device 2, the processed images, and the metadata are received and stored.

At block S407, a location of the object in the images is determined by searching the location relationship table 200 according to the identity tag of the device 2. In at least one embodiment, the location relationship table 200 records a relationship between a plurality of devices 2 and a corresponding surveillance area of the plurality of devices 2.

At block S408, a prompt is generated according to the time period of the object appearing in the images and the location of the object to notify that the object appears in the location within the time period.

In at least one embodiment, the surveillance area of each device 2 corresponds to a surveillance area of a shop. Whether a length of time of the object remaining in the surveillance area of the shop exceeds a predetermined length of time is determined. When the length of time of the object remaining in the surveillance area exceeds the predetermined length of time, a prompt is generated to notify that the object likes merchandise of the area of the shop. In at least one embodiment, whether the identity tag of the object is recorded in a first database is determined. The first database stores identity tags of a plurality of membership customers of the shop. When it is determined that the identity tag of the object matches the identity tag of one of the membership customers in the first database, a prompt that a membership customer is in the shop is generated. Thus, an employee of the shop will know that the membership customer is in the shop and will know to greet the membership customer.

In at least one embodiment, the surveillance area of each device 2 corresponds to a surveillance area of an office. A command to identify the object is received and a prompt is generated to notify that the object is located in the corresponding surveillance area of the office.

In at least one embodiment, the surveillance area of each device 2 corresponds to a surveillance area of an entrance. Whether the identity tag of the object is recorded in a second database is determined. The second database records a plurality of identity tags that have received authorization. When it is determined that the identity tag of the object is not recorded in the second database, a corresponding prompt is generated to alarm that a stranger is located in the corresponding surveillance area of the entrance.

In at least one embodiment, the surveillance area of each device 2 corresponds to a surveillance area of an entrance, and whether a time period of the object appearing in the location is within a predetermined time period is determined. When the time period of the object appearing in the location is not within the predetermined time period, a corresponding prompt is generated to alarm that the object is located in the corresponding surveillance area of the entrance outside of the predetermined time period.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An image surveillance device comprising:
a camera unit;
a communication unit; and
a processing unit coupled to the camera unit and the communication unit, wherein the processing unit is configured to:
obtain an identity tag of the image surveillance device;
obtain images captured by the camera unit;
recognize the images and establish metadata of the images, wherein the metadata comprises an identity tag of an object in the images and a time period of the object appearing in the images;
process the images according to an image processing algorithm; and
send the processed images, the metadata, and the identity tag of the image surveillance device to a server.

2. The image surveillance device of claim 1, wherein the image processing algorithm processes the images according to contrast, automatic image exposure, automatic image balance, local and global contrast optimization, image angle change processing, image sharpening, image scaling, and color space conversion processing.

3. The image surveillance device of claim 1, wherein the camera unit is a camera sensor.

4. An image surveillance method implemented on an image surveillance device and a server, comprising:
obtaining, by a processing unit of the image surveillance device, an identity tag of the image surveillance device;
obtaining, by the processing unit of the image surveillance device, images captured by the image surveillance device;
recognizing the images and establishing metadata of the images by the processing unit of the image surveillance device, wherein the metadata comprises an identity tag of an object in the images and a time period of the object appearing in the images;
processing, by the processing unit of the image surveillance device, the images according to an image processing algorithm;
sending, by the processing unit of the image surveillance device, the processed images, the metadata, and the identity tag of the image surveillance device to the server;
receiving and storing the processed images, the metadata, and the identity tag of the image surveillance device in a memory of the server by a processor of the server;
searching, by the processor of the server, a location relationship table according to the identity tag of the image surveillance device to determine a location of the object, wherein the location relationship table records a relationship between the identity tag of the image surveillance device and a surveillance area of the image surveillance device; and
generating, by a processor of the server, a prompt according to the time period of the object appearing in the images and the location of the object to notify that the object appears in the location.

5. The image surveillance method of claim 4, wherein the image processing algorithm processes the image according to contrast, automatic image exposure, automatic image balance, local and global contrast optimization, image angle change processing, image sharpening, image scaling, and color space conversion processing.

6. The image surveillance method of claim 4, wherein a surveillance area of each image surveillance device corresponds to a surveillance area of a shop, the method further comprises:
determining, by the processor of the server, according to the location of the object and a length of time of the object remaining in the location, a length of time of the object remaining in the location, and generating, by the processor of the server, when the length of time of the object remaining in the location exceeds a predetermined length of time, a prompt that the object likes merchandise of the area of the shop.

7. The image surveillance method of claim 4, wherein a surveillance area of each image surveillance device corresponds to a surveillance area of an office, and the method further comprises:
receiving, by the processor of the server, a command to identify the object; and
responding to the command and generating, by the processor of the server, according to the location of the object, a corresponding prompt to notify that the object is located in the corresponding surveillance area of the office.

8. The image surveillance method of claim 4, wherein a surveillance area of each image surveillance device corresponds to a surveillance area of an entrance, and the method further comprises:
determining, by the processor of the server, whether the identify tag of the object is recorded in a database; and
generating, by the processor of the server, when the identity tag of the object is not recorded in the database, a corresponding prompt to alarm that the object is located in the corresponding surveillance area of the entrance.

9. The image surveillance method of claim 4, wherein a surveillance area of each image surveillance device corresponds to a surveillance area of an entrance, and the method further comprises:
determining, by the processor of the server, whether a time period of the object appearing in the location is within a predetermined time period; and
generating, by the processor of the server, when the time period of the object appearing in the location is not within the predetermined time period, a corresponding prompt to alarm that the object is located in the corresponding surveillance area of the entrance.

10. A non-transitory storage medium having stored thereon instructions that, when executed by a processing unit of an image surveillance device and a processor of a server, causes the processing unit and the processor to perform an image surveillance method, wherein the method comprises:
obtaining, by the processing unit of the image surveillance device, an identity tag of the image surveillance device;
obtaining, by the processing unit of the image surveillance device, images captured by the image surveillance device;
recognizing the images and establishing metadata of the images by the processing unit of the image surveillance device, wherein the metadata comprises an identity tag of an object in the images and a time period of the object appearing in the images;
processing, by the processing unit of the image surveillance device, the images according to an image processing algorithm;
sending, by the processing unit of the image surveillance device, the processed images, the metadata, and the identity tag of the image surveillance device to the server;
receiving and storing the processed images, the metadata, and the identity tag of the image surveillance device in a memory of the server by the processor of the server;
searching, by the processor of the server, a location relationship table according to the identity tag of the image surveillance device to determine a location of the object, wherein the location relationship table records a relationship between the identity tag of the image surveillance device and a surveillance area of the image surveillance device; and
generating, by a processor of the server, a prompt according to the time period of the object appearing in the images and the location of the object to notify that the object appears in the location.

11. The non-transitory storage medium of claim 10, wherein the image processing algorithm processes the image according to contrast, automatic image exposure, automatic image balance, local and global contrast optimization, image angle change processing, image sharpening, image scaling, and color space conversion processing.

12. The non-transitory storage medium of claim 10, wherein a surveillance area of each image surveillance device corresponds to a surveillance area of a shop, the method further comprises:
determining, by the processor of the server, according to the location of the object and a length of time of the object remaining in the location, a length of time of the object remaining in the location, and generating, by the processor of the server, when the length of time of the object remaining in the location exceeds a predetermined length of time, a prompt that the object likes merchandise of the area of the shop.

13. The non-transitory storage medium of claim 10, wherein a surveillance area of each image surveillance device corresponds to a surveillance area of an office, and the method further comprises:
receiving, by the processor of the server, a command to identify the object; and
responding to the command and generating, by the processor of the server, according to the location of the object, a corresponding prompt to notify that the object is located in the corresponding surveillance area of the office.

14. The non-transitory storage medium of claim 10, wherein a surveillance area of each image surveillance device corresponds to a surveillance area of an entrance, and the method further comprises:
determining, by the processor of the server, whether the identify tag of the object is recorded in a database; and
generating, by the processor of the server, when the identity tag of the object is not recorded in the database, a corresponding prompt to alarm that the object is located in the corresponding surveillance area of the entrance.

15. The non-transitory storage medium of claim 10, wherein a surveillance area of each image surveillance device corresponds to a surveillance area of an entrance, and the method further comprises:
determining, by the processor of the server, whether a time period of the object appearing in the location is within a predetermined time period; and
generating, by the processor of the server, when the time period of the object appearing in the location is not within the predetermined time period, a corresponding prompt to alarm that the object is located in the corresponding surveillance area of the entrance.
